(19) United States
(12) Patent Application Publication
(10) Pub. No.: US 2012/0303402 A1
(43) Pub. Date: Nov. 29, 2012

(54) Real-Time Alert System and Method

(76) Inventor: Ernest Koury, El Paso, TX (US)

(21) Appl. No.: 13/482,580

(22) Filed: May 29, 2012

Related U.S. Application Data
(60) Provisional application No. 61/490,662, filed on May 27, 2011.

(51) Int. Cl. G06Q 10/10

(52) U.S. Cl. 705/7.13

(57) ABSTRACT

A system and method for communicating information about a service between at least one potential customer of the service and at least one service business that provides the service. The method comprises the exchange of information about the service between at least one service business and at least one potential customer. In one embodiment, a potential customer may request to be added to at least one waiting list of a service business. In an embodiment, a service business may schedule the delivery of services based on data collected from a potential customer, for example, the location of the customer. The system comprises one or more service business client-level computing devices and one or more potential customer computing devices.

### CROSS-REVERENCE TO RELATED APPLICATIONS

This patent claims the benefit of U.S. Provisional Application No. 61/490,662 under 35 U.S.C. §119 (e).

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND

The present invention relates to minimizing the time that a potential customer of a business must wait to receive a service from the business. For example, and without limitation, restaurants and other businesses where wait time may affect a potential customer's choice, need a method and system for providing accurate wait time information to the potential customer, updating such information provided to the potential customer, and delivering services efficiently to waiting potential customers.

Presently, a potential customer generally may only receive information about the time the potential customer must wait to receive a service from a business based on the visual estimate of business personnel. Such wait times are frequently inaccurate and may result in the potential customer seeking services from a competing business if the estimated wait time is longer than desired by the potential customer.

To manage finite ability to provide services at any given time that is less than the demand of potential customers, a business may maintain a list of potential customers waiting for services. Such a waiting list is often inefficient to a potential customer because the potential customer must stay in close proximity to the business to ensure that the potential customer is available when the business has capacity to provide service to the customer. In other situations, a business may withhold some service capacity from available potential customers due to potential customers that have made reservations for such services. However, such a reservation system is inefficient because business service capacity is withheld without certainty of when or if the potential customer that made reservations for such services will be available.

A need exists for a client-level computer-implemented system and method to assist service businesses in organizing capacity and accurately providing real-time wait time alerts, updates, and information. Prior proposed solutions to providing business wait times involved in-person phone calls and inaccurate, non-location-specific metrics used to calculate wait time. Further, prior art requires expensive, complex server computers to perform estimated time determinations. For example, see United States Patent Application US 2009/0252318 A1. Prior wait time and restaurant reservation search engines require the user to perform tedious searches of wait time information that usually do not contain up-to-the-minute real-time alerts. No real-time wait time solution has been presented that accurately and automatically transmits a real-time wait time to a system user through a potential customer's computing device. Further, no solution exists that allows a potential customer to add the potential customer to a service business waiting list without involvement of services business personnel.

### SUMMARY

The present embodiments relate to using information from a potential customer and a service business to minimize the time the potential customer must wait to receive a service from the business and maximizing the efficiency of delivery of the service by the service business to the potential customer using a client-level computing device of the business. A potential customer may use a computing device to communicate information about the services desired by the potential customer to the service business, and the service business may use a client-level computing device to estimate the time the potential customer must wait to receive the service from the business and an efficient manner for delivering the service based on the potential customer information and information about the service business's operations.

In a first aspect, a method for communicating service information to a potential customer and receiving a request for services from the potential customer is disclosed. The method comprises at least one service business client-level computing device receiving information from at least one potential customer about the potential customer, said information potentially comprising a request by a potential customer for services. The method further comprises at least one service business client-level computing device determining an estimated wait time based on the information and service request received from the potential customer, determining an updated wait time if potential customer information or service requests changes, and determining an efficient manner in which to deliver the service to the potential customer. The method further comprises transmitting the estimated wait time and updated wait time, if any, to the potential customer.

In a second aspect, a system for communicating service information to a potential customer and receiving a request for services from the potential customer is disclosed. The system includes at least one potential customer computing device and at least on service business client-level computing device. The service business client-level computing device is operable to receive information about the services desired by a potential customer and to accept at least one request for such services by the potential customer. The service business client-level computing device is further operable to determine an estimated wait time based on the information and service request received from the potential customer and to determine an efficient manner in which to deliver the service to the potential customer.

### BRIEF DESCRIPTION OF THE DRAWINGS

FIG. 1 illustrates one embodiment of a system for a service business to receive information from a potential customer, transmit service information to the potential customer and determine a manner for delivering service to the potential customer.

FIG. 2 illustrates one embodiment of a system for a service business and at least one potential customer to communicate about services of the service business.

FIG. 3 illustrates one embodiment of a system for at least one service business to communicate with at least one potential customer about services of the service business.

FIG. 4 illustrates a flowchart for a potential customer and service business to communicate about a service.

### DETAILED DESCRIPTION

The present embodiments relate to collecting information from a potential customer of a service, using said information to estimate the length of time that the potential customer of a service must wait to receive the service, communicating information about the length of time that the customer must wait to receive the service to the potential customer, and further using said information to manage delivery of the service to the potential customer.

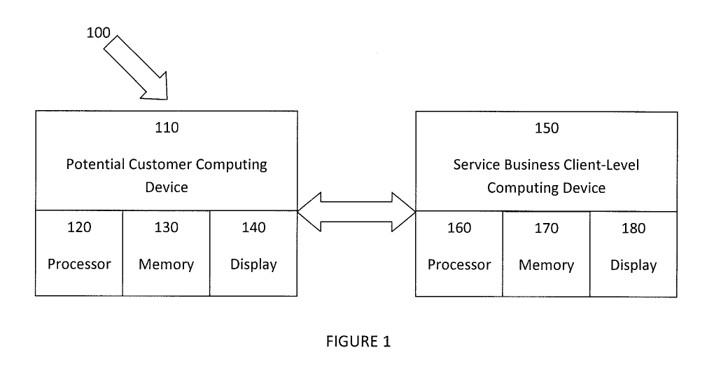

FIG. 1 shows a system 100 for a service business to receive information from a potential customer, transmit service information to the potential customer and determine a manner for delivering service to the potential customer. The system may comprise a potential customer computing device 110 and service business client-level computing device 150. Additional, different or fewer components may be provided. For example, the system 100 may include multiple potential customer computing devices 110 and/or multiple service business client-level computing devices 150. The system 100 comprises a data network that allows the potential customer computing device 110 to exchange information with the service business client-level computing device 150. Information received from the potential customer may include location information and info nation related to the nature of the services sought by the potential customer.

The potential customer computing device is a computer, tablet computer, IPad®, mobile phone or other computing device. As shown in FIG. 1, the potential customer computing device may include a processor 120, memory 130 and display 140. Additional, different, or fewer components may be provided. The potential customer computing device may further comprise location-identifying systems that allow the potential customer computing device to ascertain the location of the potential customer computing device.

The service business client-level computing device 150 a computer, tablet computer, IPad®, mobile phone or other computing device. As shown in FIG. 1, the service business client-level computing device may include a processor 160, memory, 170 and display 180. Additional, different or fewer components may be provided. The service business may be a restaurant or other business which may require potential customers to wait to receive a service from the business. For example, and without limitation, the service business may also be a medical service provider, entertainment service provider, automotive or other maintenance service provider, or any other venture providing services that may not have the capacity to provide the services immediately upon the request of a potential customer.

In another embodiment, the service business may operate a plurality of client-level computing devices 150. Service business personnel may communicate with each other regarding services, potential customers or other information via the plurality of service business client-level computing devices 150.

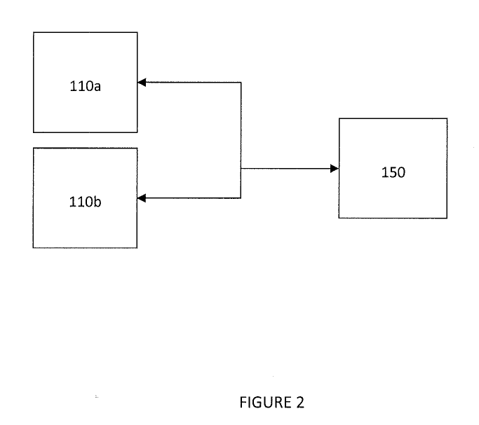

FIG. 2 shows an embodiment of the present invention in which multiple potential customer computing devices 100a and 100b communicate with a service business client-level computing device 150. For example, a first potential customer of a business may use the potential customer computing device of the first potential customer 100a to provide the service business client-level computing device 150 with information about services desired by the first potential customer. The potential customer computing device of the first potential customer 100a may communicate with the service business client-level computing device 150 via the internet or a combination of the internet and a mobile device telecommunication or data provider network. The service business client-level computing device 150 may determine an estimated time that the first potential customer must wait based on the information received from the potential customer computing device of the first potential customer 100a and communicate an estimated wait time to the first potential customer.

A second potential customer of the business may use the potential customer computing device of the second potential customer 100b to provide the service business client-level computing device 150 with information about services desired by the first potential customer. The potential customer computing device of the second potential customer 100b may communicate with the service business client-level computing device 150 via the internet or a combination of the internet and a mobile device telecommunication or data provider network. The service business client-level computing device 150 may determine an estimated time that the second potential customer must wait based on the information received from the potential customer computing device of the first potential customer 100b and communicate an estimated wait time to the second potential customer.

The service business client-level computing device 150 may receive additional information from the potential customer computing device of the first potential customer 100a, for example information regarding the location of the first potential customer or a change in the services sought by the first potential customer. The service business client-level computing device 150 may estimate the wait time for the second potential customer based on the additional information from the first potential customer and communicate changes in the estimated wait time for the second potential customer to the potential customer computing device of the second potential customer 100b.

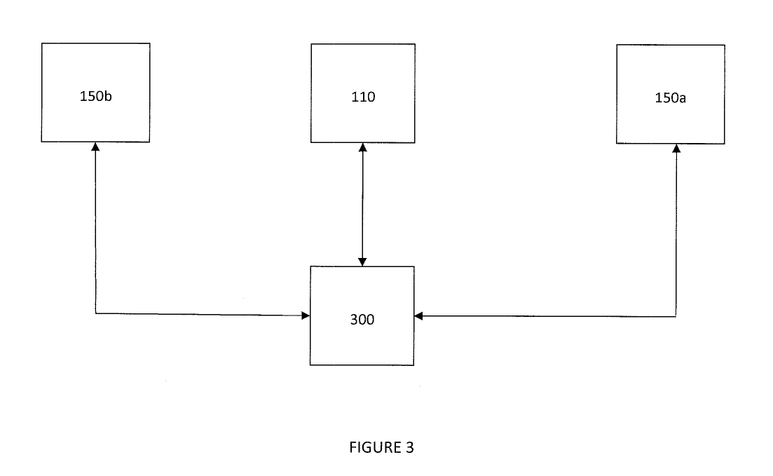

FIG. 3 shows another embodiment of the present invention in which at least one service business client-level computing device, 150a and 150b, communicates with a potential customer computing device 110 indirectly via a centralized computer 300. In this embodiment, the centralized computer 300 may receive wait time information from multiple service businesses and transmit the wait time information from multiple service businesses to the potential customer computing device 110. The potential customer may then make a decision about which service business the potential customer wishes to receive services from based on a comparison of wait times. The service business client-level computing device of each service business, 150a and 150b, may update wait time information based on changes in information received from the potential customer and other potential customers and transmit updated wait time information indirectly to the potential customer computing device 110. Multiple potential customer computing devices may communicate with the centralized computer 300 and receive service information from desired service business client-level computing devices.

In another embodiment, the centralized computer 300 may transmit advertisements to the potential customer computing device 110. Advertisements transmitted to potential customer computing device 110 by the centralized computer 300 may be selected based on the services sought by the potential customer.

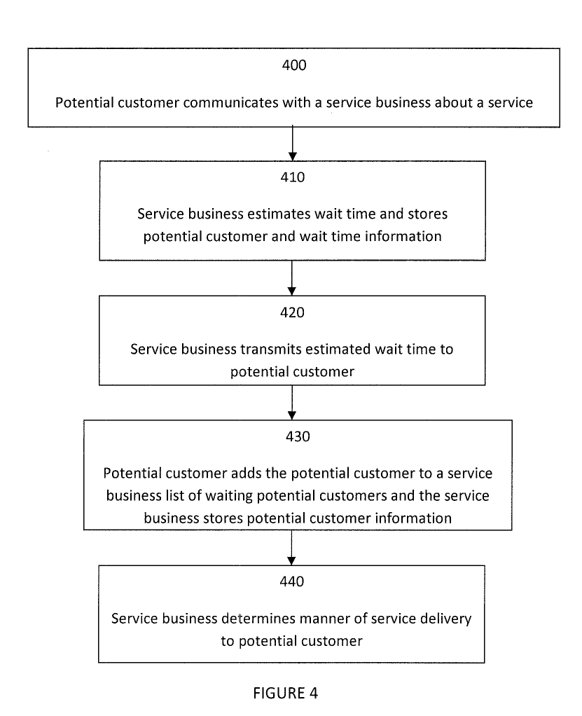

FIG. 4 shows a method for communicating service information between at least one potential customer and a service business. The method is implemented by using the system 100. Additional, different or fewer acts than shown in FIG. 4 may be provided and the acts may be performed in a different order. For example, the method may comprise the potential customer providing information to the service business at periodic intervals after an initial communication between the potential customer and the service business and the service business may provide the potential customer with updated service information at periodic intervals to reflect changes in service information.

In act 400 a potential customer communicates with a service business about a service. Such communication may comprise information about the service requested by the potential customer. For example, the potential customer may specify a medical service requested from a medical service provider or a specific seating capacity from a restaurant. In another example, a potential customer provides reservation data (e.g., party size, name, mobile communications device number, etc.) to a restaurant.

In act 410 the service business may determine an estimated wait time for a potential customer to receive a requested service. The service business may determine the wait time using an algorithm or formula implemented via the service business's client-level computing device (e.g., iPad® or tablet) to accurately calculate wait time based on unique metrics of the service business. For example, a restaurant may determine an estimated wait time based on historic customer dining patterns, party sizes and seating capacity.

In act 420 the service business communicates an estimated wait time to a potential customer. The estimated wait time may be communicated directly to the potential customer. Alternatively, estimated wait times determined by multiple service businesses that provide comparable services may be communicated to a centralized computer that communicates the estimated wait times for the multiple service businesses to at least one potential customer. Service business personnel may manually enter or edit wait time estimates determined by the service business client-level computing device. Further, the service business may communicate information about services to a potential customer including, without limitation, special pricing available on certain services.

In act 430 a potential customer adds the potential customer to a list of potential customers of a service business that are waiting for service. The potential customer may add the potential customer to the list via the computing device of the potential customer without personally communicating with service business personnel. The service business may adjust estimated wait times based on the number of potential customers on a list of potential customers waiting for services and the nature of the services sought by those customers.

In act 440 the service business may manage its delivery of services based on information received from potential customers. For example, if a potential customer requests services at a specific time, but information from the potential customer, such as location information, indicates that the potential customer will be late, the service business may prioritize service delivery to another potential customer that is ready to receive services. Similarly, if a potential customer requests a certain quantity of services, but information received from the potential customer after the request indicates that the quantity of services requested has changed, the service business may adjust service delivery to efficiently address the needed quantity by providing or withholding certain services to or from other potential customers. Further, the service business may alert a potential customer when the service business is available to serve the potential customer. For example, if a potential customer's table is available in a restaurant, the service business client-level computing device sends an automatic text message alert, email, and/or automated phone call to the potential customer's computing device. As another example, if location information indicates that a potential customer is in close proximity to the service business, the service business may move the potential customer to the top of the service business's waiting list.

1. A method for increasing the efficiency of the delivery of a service to at least one potential customer by a service business that maintains a waiting list, the method comprising:
a service business storing data about the service business's delivery of services in a non-transitory computer readable medium;
a service business client-level computing device estimating the time that the potential customer must wait to receive the service based on the stored data about the service business's delivery of services;
transmitting data about the estimated time that the potential customer must wait to receive the service from the service business;
collecting data from at least one potential customer computing device, said data comprising a request to be added to the waiting list of the service business;
storing the data collected from the at least one potential customer in a non-transitory computer readable medium; and
scheduling the delivery of service by the service business to the at least one potential customer based on the data collected from the at least one potential customer and the data about the service business's delivery of services.

2. The method of claim 1 wherein the data collected from at least one potential customer computing device further comprises data regarding the location of the potential customer computing device.

3. The method of claim 2 wherein, with respect to communication between at least one potential customer and the service business about a service, data is collected from the potential customer computing device on more than one occasion.

4. The method of claim 3 wherein the client-level computing device of a service business re-estimates the time that a potential customer must wait to receive the service if data collected from the potential customer or about the service business's delivery of services changes.

5. The method of claim 1 wherein the service business transmits data about the estimated wait time that the potential customer must wait to receive service from the service business on the occurrence of specific situations, said situations comprising a change in the estimated wait time or changes in location of the potential customer.

6. The method of claim 1 wherein advertisements are displayed on the potential customer computing device based on the collected data.

7. The method of claim 1 wherein the service business client-level computing device may communicate with other computing devices of the service business.

8. A system for increasing the efficiency of the delivery of a service to a potential customer by a service business that maintains a waiting list, the system comprising:
a plurality of potential customer computing devices, the potential customer computing devices comprising a first potential customer computing device;
at least one waiting list of at least one service business stored in a non-transitory computer readable medium;
at least one service business client-level computing device; and
wherein each potential customer computing device is operable to communicate with at least one service business client-level computing device;
wherein each service business client-level computing device is operable to communicate with at least the first potential customer computing device;
wherein each service business client-level computing device is further operable to modify the waiting list of the service business; and
wherein each service business client-level computing device is further operable to estimate the amount of time a potential customer must wait to receive service from the service business.

9. The system of claim 8 wherein a service business client-level computing device comprises a tablet computer.

10. The system of claim 8 wherein a service business client-level computing device comprises a portable computer.

11. The system of claim 8 wherein a service business client-level computing device comprises a mobile telecommunication device.

12. The system of claim 8 wherein each potential customer computing device is operable to display advertisements.

13. The system of claims 8 and 12 wherein the client-level computing device of a service business is operable to communicate with other computing devices of the service business.

14. A computer readable storage medium, the computer readable storage medium being non-transitory, the computer readable storage medium comprising instructions for communicating service information that are processable by a computer device, the instructions defining a method, the method comprising:
a service business storing data about the service business's delivery of services in a non-transitory computer readable medium;
a service business client-level computing device estimating the time that the potential customer must wait to receive the service based on the stored data about the service business's delivery of services;
transmitting data about the estimated time that the potential customer must wait to receive the service from the service business;
collecting data from at least one potential customer computing device, said data comprising a request to be added to the waiting list of the service business;
storing the data collected from the at least one potential customer in a non-transitory computer readable medium; and
scheduling the delivery of service by the service business to the at least one potential customer based on the data collected from the at least one potential customer and the data about the service business's delivery of services.
